(19) United States
(12) Patent Application Publication
(10) Pub. No.: US 2003/0104148 A1
(43) Pub. Date: Jun. 5, 2003

(54) Plastic laminated cloth containers

(76) Inventors: Brad Marx, Washington, DC (US); Seung Ho Choi, Kwangmyung-City (KR)

Correspondence Address: COLLIER SHANNON SCOTT, PLLC, 3050 K STREET, NW, SUITE 400, WASHINGTON, DC, 20007, US

(21) Appl. No.: 10/000,528

(22) Filed: Dec. 4, 2001

(51) Int. Cl. B32B 1/02

(52) U.S. Cl. 428/35.2; 428/36.1; 156/277; 156/93

(57) ABSTRACT

A flexible cloth container having a translucent or transparent plastic layer laminated to the interior surface of the cloth container is disclosed. The flexible cloth container may have a decorative design printed thereon. The use of a translucent or transparent plastic layer may render the cloth container water-resistant or water-proof without interfering with the outward appearance of the container.

### FIELD OF THE INVENTION

The present invention relates to woven cloth items that are treated on an interior surface with a plastic laminate to render the cloth water-proof, water-resistant, or water-repellant.

### BACKGROUND OF THE INVENTION

Woven cloth provides an excellent medium from which to construct decorative flexible containers, such as handbags, backpacks, lunch bags, etc. Two primary alternatives dominate the flexible container market: plastic containers and cloth containers. Most consider the “look,” texture, and feel of cloth to be desirable as compared with plastic. As compared with plastic, cloth stays flexible in cool weather, does not become excessively hot in the sun, does not stick to skin, and is readily washable. Cloth is also desirable for decorative purposes because a near infinite number of designs and color schemes can be applied to it. These designs may be printed on it, or alternatively, woven into the cloth using a selection of colored threads.

Flexible containers may be used to transport an infinite variety of personal items. In many instances users may wish to use such flexible containers to transport liquid containers, such as water, soda, juice, or alcohol bottles and cans. These liquid containers may be prone to leak and “sweat” (form condensation). This liquid leakage or sweat can soak through woven cloth quite easily, making it temporarily darker in wet spots, permanently staining it, and allowing leakage to spill out onto a user's clothing or surroundings. Accordingly, flexible containers constructed solely of woven cloth are not well suit for transporting liquid containers.

In other instances, the aforementioned flexible containers may be used to carry items that the user wishes to keep dry, such as extra clothing, food, paper products, etc. Untreated woven cloth containers, however, do not provide a substantial barrier to rain and snow. Accordingly, if rain, snow, or other moisture contacts the outer surface of an untreated woven cloth container it is likely that the moisture will soak through the cloth and as a result the items within the container will become wet.

Because they fail both to keep liquid from leaking out, and prevent rain and snow from getting in, untreated flexible cloth containers have proven unsatisfactory for many backpack, handbag, lunch bag, etc. applications. In order to avoid the foregoing challenges associated with untreated flexible cloth containers many manufacturers choose not use cloth at all, but instead use a flexible plastic material, such as vinyl, to form the container. While the use of flexible plastic solves the moisture barrier problems of untreated cloth containers, the look, feel, design, and overall aesthetic impression of such plastic containers is considered by most to be inferior to that of cloth containers.

Another potential solution to the problems associated with the use of cloth containers to contain and repel liquids is to treat the cloth with a material such as PTFE (Teflon®). PTFE treatment, however, does not provide a very effective solution to this problem. PTFE treatment is expensive, and in order for the treatment to be effective, the cloth that is treated must have a fairly fine weave, making it even more expensive. Further, PTFE does not render the cloth water-proof, but merely water-resistant. Still further, PTFE does not hold up to repeat washing, and therefore the water-resistant quality of the treated cloth will diminish with each washing of the container.

Rather than abandon the use of cloth altogether, the present applicants strove to solve the moisture barrier problems associated with flexible cloth containers by laminating the interior cloth surface of the container with a flexible layer or coating of plastic, preferably PVC. The PVC laminate provides an excellent barrier to moisture flow both from the outside of the container in, and the inside of the container out.

Because the outer surface of applicants' cloth containers are cloth, it is possible to produce a themed line of clothing and cloth containers that match in look, texture, and feel. Matching themed cloth containers and clothing are sought by sports fans in particular. Fans desire to have matching cloth containers and clothing items with their favorite college and professional team colors and designs.

Applicants were pleased with their cloth-PVC laminate containers until they began to produce “themed” flexible cloth containers that were supposed to match the color schemes of clothing items. The problem with matching the color of the clothing and the container arose because the PVC material originally used to coat the interior of the cloth was white. The white PVC tended to show through the outer cloth surface of applicants' containers. By showing through, the white PVC tended to make the colors of the cloth container appear lighter in shade than the colors of the clothing items made out of the same (or matching) cloth. Therefore, use of the PVC laminate defeated the color matching advantages of constructing a cloth container and clothing out of the same or matching cloth.

### OBJECTS OF THE INVENTION

It is therefore an object of the present invention to provide a flexible cloth container that is water-proof, water-resistant, or water-repellant, and that will match clothing items in terms of color.

It is another object of the present invention to provide a flexible cloth container that is water-proof, water-resistant, or water-repellant, and that will match clothing items in terms of look and texture.

It is still another object of the present invention to provide a method of making a flexible cloth container that is water-proof, water-resistant, or water-repellant, and that will match clothing items in terms of color and texture.

It is yet another object of the present invention to provide a flexible cloth container that includes an interior laminate that is water-proof, water-resistant, or water-repellant, and does not substantially show through the outer cloth layer of the container.

It is still yet another object of the present invention to provide a method of making a flexible cloth container that includes an interior laminate that is water-proof, water-resistant, or water-repellant, and does not substantially show through the outer cloth layer of the container.

Additional objects and advantages of the invention are set forth, in part, in the description which follows and, in part, will be apparent to one of ordinary skill in the art from the description and/or from the practice of the invention.

### SUMMARY OF THE INVENTION

Responsive to the foregoing challenges, Applicants have developed an innovative flexible container comprising: an outer cloth layer; and an inner plastic layer laminated to the outer cloth layer, wherein the inner plastic layer is translucent or transparent.

Applicants have also developed a method of manufacturing a flexible container comprising the steps of: preparing cloth fabric for printing; printing a design on the cloth fabric; laminating a transparent or translucent inner plastic layer to the cloth fabric to form laminated cloth; cutting a flexible container pattern from the laminated cloth; and sewing the pattern into a flexible container.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

In order to assist the understanding of this invention, reference will now be made to the appended drawings, in which like reference numerals refer to like elements. The drawings are exemplary only, and should not be construed as limiting the invention.

FIG. 1 is a pictorial view of a flexible cloth container that includes an interior plastic layer.

FIG. 2 is an enlarged pictorial view of a portion of the flexible cloth container shown in FIG. 1 in accordance with a first embodiment of the invention.

FIG. 3 is a flow chart of the steps used to make flexible cloth containers having an interior plastic layer in accordance with a first embodiment of the invention.

FIG. 4 is an enlarged pictorial view of a portion of a flexible cloth container in accordance with a second embodiment of the invention.

FIG. 5 is a flow chart of the steps used to make flexible cloth containers having an interior plastic layer in accordance with a second embodiment of the invention.

### DETAILED DESCRIPTION OF PREFERRED EMBODIMENTS OF THE INVENTION

Reference will now be made in detail to a preferred embodiment of the present invention, an example of which is illustrated in the accompanying drawings. With reference to FIG. 1, a cloth container 100 is shown. The container 100 includes an outer cloth layer 110 and an inner plastic layer 120. The cloth layer 110 includes a decorative pattern 112 that is printed on, or woven into the cloth layer.

In the preferred embodiment, the cloth may be 100% carded cotton woven fabric with a thread count of 20 for both the warp and the weft. The cloth may be processed in 63 inch wide bolts. The weave creates a pattern of 60×60 squares per inch. The cloth may weigh approximately 220 grams per yard as a grey good (a raw good before it is processed for printing and printed). Prior to lamination, the grey good may be scoured to remove natural coloring matters. The cloth is then bleached to impart whiteness by destroying the natural impurities. Bleaching helps prepare the cloth for dyeing and/or printing. Next the cloth is mercerized, which consists of treating the cloth with caustic soda while under tension to give it luster, strength and improved dye uptake. The cloth may also be procured to improve its absorption of conventional dyes. Following the foregoing pretreatment steps, the cloth may be dyed and/or printed. The cloth may weigh approximately 201 grams per yard after dying and printing, and is reduced from approximately 63 inches wide to 56 to 57 inches wide.

The inner plastic layer 120 is preferably formed of clear or translucent untinted Poly Vinyl Chloride (PVC). The PVC is preferably in the range of approximately 0.2 to 0.3 mm thick, and more preferably approximately 0.25 mm thick. The PVC preferably weighs approximately 20 to 40 grams per yard.

With reference to FIG. 3, the cloth container 100 may be formed using the following process. The grey goods cloth is provided in sheets approximately 63 inches wide in step 200. The cloth is scoured, bleached, mercerized, precured, dyed, and printed in steps 210, 220, and 230. Reactive dyes (wet print) may be printed onto the cloth layer 110 to form the decorative pattern 112. Wet printing is preferred because it may allow greater color vibrancy and range. Wet printing may also be more economical because it may reduce set up time and thereby permit the use of a greater number of colors given a fixed budget.

In step 240, the inner plastic layer 120 is laminated to the cloth 110 using an adhesive. A urethane based adhesive is used in the preferred embodiment. The urethane based adhesive may comprise approximately (30%) thirty percent urethane, (50%) solvent such as methyl ethyl ketone (MEK), and (20%) two materials that promote easy adhesion and quick reaction. This adhesive may be roll coated onto the plastic layer 120. The plastic layer 120 may then be laminated to the cloth layer 110 by physically pressing the two layers together at a temperature of approximately 180 to 200 degrees Celsius and under a pressure of approximately 20 to 30 kilograms.

In step 250 the pattern for the cloth container is cut from the cloth sheet. In step 260 the cut out pattern is sewed together to form the cloth container.

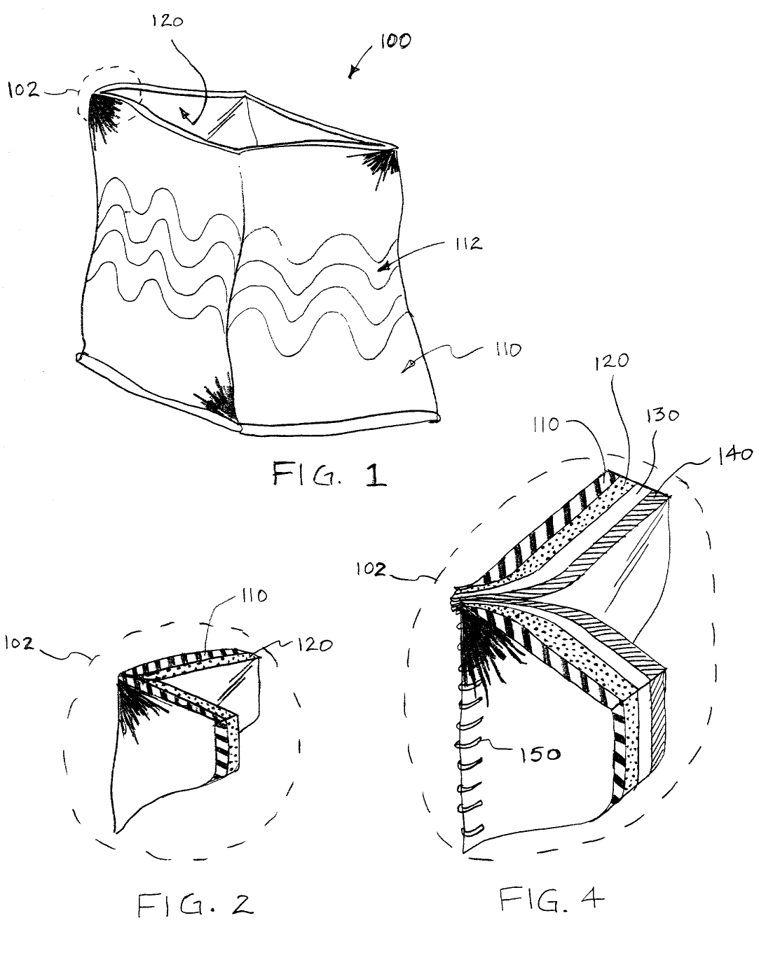

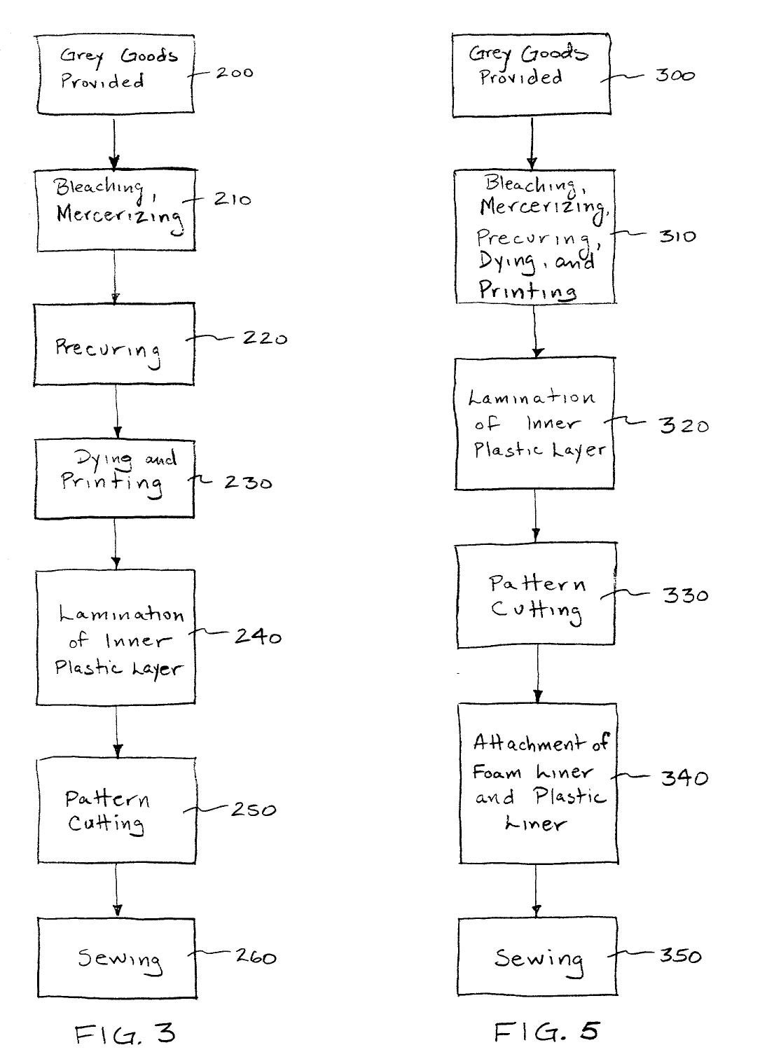

An alternative embodiment of the invention is shown in FIG. 4, in which like reference numerals refer to like elements. With reference to FIG. 4, the cloth container 100 includes two layers in addition to the cloth layer 110 and the inner plastic layer 120. A foam liner 130 and a plastic liner 140 are attached to the inner surface of the container. Preferably, the foam liner 130 may be constructed of polyethylene or polyurethane and may be in the range of 3 to 7 mm thick.

The plastic liner 140 may be constructed of PVC of any color or lack thereof, but preferably white. The plastic liner 140 may be in the range of approximately 0.2 to 0.25 mm thick, and is preferably about 0.22 mm thick. The foam liner 130 and the plastic liner 140 are preferably precut and sewed to the cloth layer 110 and the inner plastic layer 120 of the container. All of the layers may be sewed together using thread 150.

With reference to FIG. 5, the cloth container shown in FIG. 4 may be constructed using the following process. In step 300 the grey goods cloth is provided, and in step 310 the cloth is scoured, bleached, mercerized, procured, dyed, and printed. In step 320 the inner plastic layer 120 is laminated to the cloth layer 110 in the same manner as described above. In step 330 the pattern used to create the container is cut from the cloth. In step 340 a precut foam liner 130 and plastic liner 140 are sewn to the cloth/inner plastic layer laminate. In step 350 the cloth container is sewed to form its final shape.

It will be apparent to those skilled in the art that variations and modifications of the present invention can be made without departing from the scope or spirit of the invention. For example, the plastic material used to form the inner plastic layer may be any plastic material that is clear or translucent, and be of any thickness without departing from the scope of the invention. The foam liner and the plastic liner may be constructed of any foam and plastic (preferably flexible) material, respectfully, and may be of any thickness. Furthermore, the cloth layer may be constructed of any natural or artificial fiber with any thread count without departing from the intended scope of the invention. The cloth containers may have any shape, size, and decorative design. The decorative designs may be woven into the fabric or printed thereon. The printing process used to decorate the cloth containers is not limited to wet printing, but could comprise sublimation, pigment, photo printing, or other printing techniques, for example. Thus, it is intended that the present invention cover all such modifications and variations of the invention, provided they come within the scope of the appended claims and their equivalents.

What is claimed is:

1. A flexible container comprising:
an outer cloth layer; and
an inner plastic layer laminated to the outer cloth layer, wherein the inner plastic layer is translucent or transparent.

2. The container of claim 1 further comprising a design printed on the outer cloth layer.

3. The container of claim 1 further comprising a wet printed design on the outer cloth layer.

4. The container of claim 1 wherein the outer cloth layer is 100% carded cotton with a thread count of approximately 20 for warp and weft.

5. The container of claim 1 wherein the inner plastic layer is approximately 0.2 to 0.3 millimeters thick.

6. The container of claim 1 further comprising a foam liner and a plastic liner attached to the cloth layer and inner plastic layer.

7. The container of claim 6 wherein the foam liner is approximately 3 to 7 millimeters thick.

8. The container of claim 6 wherein the plastic liner is approximately 0.2 to 0.25 millimeters thick.

9. The container of claim 1 wherein the inner plastic layer comprises PVC.

10. The container of claim 9 wherein the inner plastic layer is approximately 0.2 to 0.3 millimeters thick.

11. The container of claim 10 further comprising a wet printed design on the outer cloth layer.

12. The container of claim 11 further comprising a foam liner and a plastic liner attached to the cloth layer and inner plastic layer.

13. The container of claim 12 wherein the foam liner is approximately 0.3 to 0.7 millimeters thick.

14. The container of claim 13 wherein the plastic liner is approximately 0.2 to 0.25 millimeters thick.

15. The container of claim 1 wherein the inner plastic layer is laminated to the outer cloth layer using an adhesive.

16. The container of claim 15 wherein the adhesive comprises urethane and MEK.

17. A method of manufacturing a flexible container comprising the steps of:
preparing cloth fabric for printing;
printing a design on the cloth fabric;
laminating a transparent or translucent inner plastic layer to the cloth fabric to form laminated cloth;
cutting a flexible container pattern from the laminated cloth; and
sewing the pattern into a flexible container.

18. The method of claim 18 further comprising the step of:
attaching a foam liner and a plastic liner to the laminated cloth.

19. The method of claim 18 wherein the step of laminating comprises adhering the inner plastic layer to the cloth fabric with an adhesive comprising urethane.
